(19) United States
(12) Patent Application Publication
(10) Pub. No.: US 2026/0018900 A1
(43) Pub. Date: Jan. 15, 2026

(54) INFORMATION PROCESSING DEVICE, INFORMATION PROCESSING METHOD, AND NON-TRANSITORY COMPUTER READABLE MEDIUM

(71) Applicant: TOHOKU UNIVERSITY, Miyagi (JP)

(72) Inventors: Toshihiko NAKATA, Miyagi (JP); Hiroaki ONODERA, Miyagi (JP)

(73) Assignee: TOHOKU UNIVERSITY, Miyagi (JP)

(21) Appl. No.: 19/334,944

(22) Filed: Sep. 21, 2025

Related U.S. Application Data
(63) Continuation of application No. PCT/JP2024/011226, filed on Mar. 22, 2024.

(30) Foreign Application Priority Data
Mar. 22, 2023 (JP) 2023-045268

(51) Int. Cl. H02J 3/38; H02J 13/00

(52) U.S. Cl. CPC H02J 3/38; H02J 13/00006

(57) ABSTRACT

An information processing device communicating with a terminal includes: a control unit generating an energy flow diagram showing a relationship between energy supply and demand for a region specified by a terminal based on data of the region, and a communication unit providing the energy flow diagram to the terminal. The energy flow diagram includes an object arranged in each energy resource domain, an energy conversion domain, and an energy demand domain, and a flow from the energy resource toward demand domain through the energy conversion domain. The object arranged in the energy resource domain includes a first resource object corresponding to potentials of all renewable energy resources in the region, and one or more second resource objects corresponding to each of one or more types of renewable energy resources having potentials in the region. The flow output from the first resource object is input to the second resource object.

### CROSS-REFERENCE TO RELATED APPLICATION

This application is a continuation of PCT International Application No. PCT/JP2024/011226, filed on Mar. 22, 2024, which claims priority under 35 U.S.C § 119(a) to Japanese Patent Application No. 2023-045268, filed on Mar. 22, 2023. Each of the above application(s) is hereby expressly incorporated by reference, in its entirety, into the present application.

### TECHNICAL FIELD

The disclosure relates to an information processing device, an information processing method, a non-transitory computer readable medium etc.

### RELATED ART

Energy flow is known to show the relationship between energy supply and energy demand.

For example, Non-Patent Document 1 discloses an energy flow proposed by the Department of Energy & Climate Change of UK, Non-Patent Document 2 discloses an energy flow proposed by the Lawrence Livermore National Laboratory of US, and Non-Patent Document 3 discloses an energy flow (referred to as Sankey Diagram) proposed by the International Energy Agency.

### PRIOR ART DOCUMENT(S)

### [Non-patent Document(s)]

[Non-patent Document 1] http://2050-calculator-tool.decc.gov.uk/#/calculator
[Non-patent Document 2] https://flowcharts.llnl.gov/
[Non-patent Document 3] https://iea.org/sankey/

The disclosure provides a method for facilitating the understanding of a relationship between energy supply and energy demand for each region.

### SUMMARY

According to the first aspect of the disclosure, an information processing device is provided. The information processing device communicates with a terminal and includes: a control unit, generating an energy flow diagram that indicates a relationship between energy supply and energy demand related to a region specified by a user of the terminal based on data of the region; and a communication unit, providing the energy flow diagram to the terminal. The energy flow diagram includes: an object arranged in each of an energy resource domain, an energy conversion domain, and an energy demand domain; and a flow from the energy resource domain toward the energy demand domain via the energy conversion domain. The object arranged in the energy resource domain includes: a first resource object corresponding to potentials of all renewable energy resources in the region; and one or more second resource objects, respectively corresponding to one or more types of renewable energy resources having potentials in the region. The flow output from the first resource object is input to the second resource object. According to the second aspect of the disclosure, a non-transitory computer readable medium is provided and stores a program. The program is executed by an information processing device communicating with a terminal and includes: generating, through control of the information processing device, an energy flow diagram indicating a relationship between energy supply and energy demand related to a region specified by a user of the terminal based on data of the region; and providing the energy flow diagram to the terminal by using a communication unit of the information processing device. The energy flow diagram includes: an object arranged in each of an energy resource domain, an energy conversion domain, and an energy demand domain; and a flow from the energy resource domain toward the energy demand domain via the energy conversion domain. The object arranged in the energy resource domain includes: a first resource object corresponding to potentials of all renewable energy resources in the region; and one or more second resource objects, respectively corresponding to one or more types of renewable energy resources having potentials in the region. The flow output from the first resource object is input to the second resource object.

According to a third aspect of the disclosure, an information processing method is provided. The information processing method is provided for an information processing device communicating with a terminal and includes: generating, through control of the information processing device, an energy flow diagram indicating a relationship between energy supply and energy demand related to a region specified by a user of the terminal based on data of the region; and providing the energy flow diagram to the terminal by using a communication unit of the information processing device. The energy flow diagram includes: an object arranged in each of an energy resource domain, an energy conversion domain, and an energy demand domain; and a flow from the energy resource domain toward the energy demand domain via the energy conversion domain. The object arranged in the energy resource domain includes: a first resource object corresponding to potentials of all renewable energy resources in the region; and one or more second resource objects, respectively corresponding to one or more types of renewable energy resources having potentials in the region. The flow output from the first resource object is input to the second resource object.

### Effects of Invention

According to the disclosure, it is possible to facilitate the understanding of the relationship between energy supply and energy demand for each region.

### BRIEF DESCRIPTION OF DRAWINGS

FIG. 1 is a diagram showing an example of functional blocks of an information processing device.

FIG. 2 is a diagram showing an example of an overview of energy supply and demand.

FIG. 3 is a diagram showing an example of data used for creating an energy flow diagram.

FIG. 4 is a diagram showing an example of an energy consumption statistics table.

FIG. 5 is a diagram showing an example of data used for estimating energy consumption by municipality.

FIG. 6 is a diagram showing an example of local power generation cost.

FIG. 7 is a diagram showing an example of aggregated data for obtaining energy export amounts and energy import amounts for respective regions.

FIG. 8 is a diagram for describing an energy flow diagram.

FIG. 9 is a diagram for describing an energy flow diagram.

FIG. 10 is a diagram showing a specific example of an energy flow diagram.

FIG. 11 is a diagram showing a specific example of an energy flow diagram.

FIG. 12 is a diagram showing a specific example of an energy flow diagram.

FIG. 13 is a diagram showing a specific example of an energy flow diagram.

FIG. 14 is a flowchart showing an example of a flow of a process performed by an information processing device.

FIG. 15 is a diagram showing an example of a configuration of a system and a server.

FIG. 16 is a diagram showing an example of a configuration of a terminal.

### DESCRIPTION OF EMBODIMENTS

Hereinafter, an example of an embodiment for implementing the disclosure will be described with reference to the drawings.

In the description of the drawings, the same elements are denoted by the same reference numerals, and duplicate descriptions may be omitted.

Moreover, the components described in the embodiment are merely examples, and are not intended to limit the scope of the disclosure thereto.

### <Configuration of Information Processing Device>

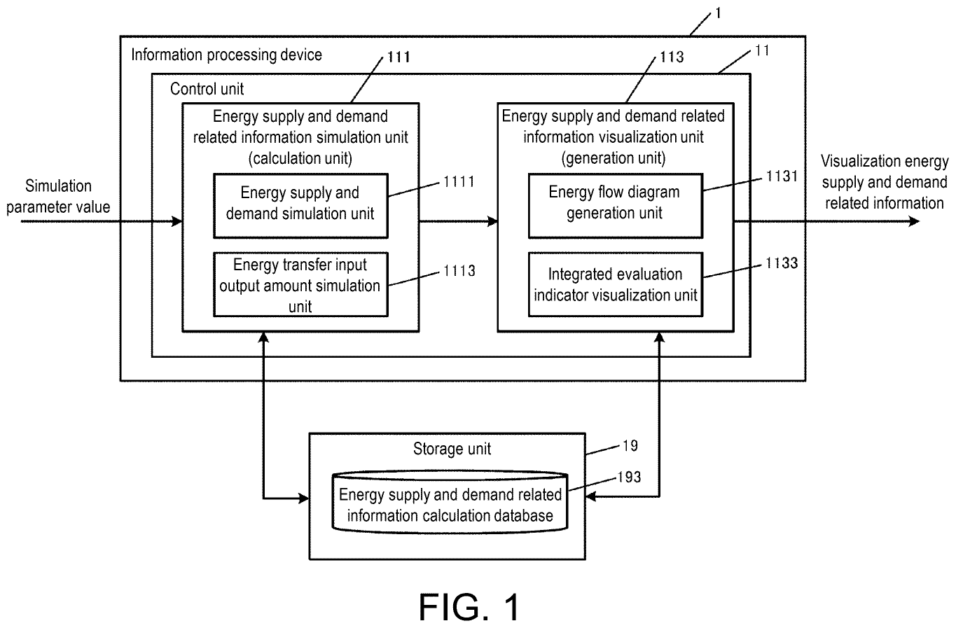

FIG. 1 is a diagram showing an example of a configuration of an information processing device 1 in the embodiment.

The information processing device 1 includes, as an example of functional blocks, a control unit 11 and a storage unit 19.

Other functional blocks included in the information processing device 1 are omitted from illustration here.

The control unit 11 can be, for example, a control device (processing device) that comprehensively controls respective units of the own device according to various programs, such as system programs stored in the storage unit 19, and performs various processes, and may be configured to have processing circuits such as a central processing unit (CPU), a graphics processing unit (GPU), a digital signal processor (DSP), an application specific integrated circuit (ASIC), a field programmable gate array (FPGA), and the like.

The storage unit 19 may be a storage device configured to have, for example, a volatile or non-volatile memory such as a read only memory (ROM), an electrically erasable programmable read only memory (EEPROM), a flash ROM, a random access memory (RAM), and an external storage device, such as a hard disk.

The control unit 11 has, for example, an energy supply and demand related information simulation unit 111 and an energy supply and demand related information visualization unit 113 as functional units.

The energy supply and demand related information simulation unit 111 calculates energy supply and demand related information based on simulation parameter values, which are values of simulation parameters acquired by inputting or receiving through an input unit or a communication unit (not shown), for example.

Energy supply and demand related information may be information having some relationship with at least one of energy demand and supply, where information related to demand includes information about factors that cause demand to fluctuate, and information related to supply may include information about factors that cause supply to fluctuate.

The simulation parameter values may be input by users such as, for example, a user of the information processing device 1 (a business operator providing such service or an administrator of the information processing device 1), or a user of a terminal 20 (general user) described later that communicates with the information processing device 1.

The simulation parameters will be described later.

The energy supply and demand related information simulation unit 111 has, for example, an energy supply and demand simulation unit 1111 and an energy transfer input output amount simulation unit 1113 as functional units.

The energy supply and demand simulation unit 1111 calculates and simulates energy supply and demand related information based on, for example, simulation parameter values and various databases stored in the storage unit 19.

The energy transfer input output amount simulation unit 1113 calculates energy transfer input output amounts based on, for example, input simulation parameter values and various databases stored in the storage unit 19.

The energy supply and demand related information visualization unit 113 is a functional unit that performs a process to visualize the energy supply and demand related information calculated by the energy supply and demand related information simulation unit 111, and has, for example, an energy flow diagram generation unit 1131 and an integrated evaluation indicator visualization unit 1133 as functional units.

The energy flow diagram generation unit 1131 generates (visualizes) an energy flow diagram described later based on, for example, calculation results of the energy supply and demand related information simulation unit 111.

The energy flow diagram may be generated as, for example, a Sankey chart.

The integrated evaluation indicator visualization unit 1133 generates (visualizes) integrated evaluation indicators (integrated evaluation indicator information), which are comprehensive evaluation indicators, based on, for example, calculation results of the energy supply and demand related information simulation unit 111.

The integrated evaluation indicators may include, for example, the following indicators.
Energy self-sufficiency rate
Energy import dependency rate
Local renewable energy introduction rate
Energy-derived CO₂ emission amount
Renewable energy electric power generation cost
Regional energy economic balance
Total primary energy supply amount
Final energy consumption

The energy flow diagram is excluded from the integrated evaluation indicators, but the energy flow diagram may be included in the integrated evaluation indicators. Additionally, the various indicators including the energy flow diagram described above may be defined as multifaceted evaluation indicators.

The storage unit 19 includes, for example, programs necessary for the control unit 11 of the information processing device 1 to perform various processes, and also includes an energy supply and demand related information calculation database 193, which is a database storing data used for calculation of energy supply and demand related information (for example, data represented in table or table format).

The data included in the energy supply and demand related information calculation database 193 will be described later.

The energy supply and demand related information calculation database 193 does not necessarily need to be stored in the storage unit 19 of the information processing device 1, and may be stored in an external device with which the information processing device 1 can communicate.

The information processing device 1 outputs processing results of the energy supply and demand related information visualization unit 113 (visualization results, visualized energy supply and demand related information (hereinafter, may be referred to as “visualized energy supply and demand related information”)).

The visualized energy supply and demand related information may include information for visualizing processing results of the energy supply and demand related information simulation unit 111 (calculation results, calculated energy supply and demand related information).

The “output” of information may refer to a concept that includes at least any one of the following.
Output of internal information of own device (output of information from one functional unit to another functional unit, etc.)
Display on a display device (display device of an external device, display device of the information processing device 1)
Transmission to an external device (transmission by the communication device of the information processing device 1)

The external device may include, for example, a user's terminal 20, etc., which will be described later.

Also, the information processing device 1 may output not only the processing results of the energy supply and demand related information visualization unit 113, but also the processing results (calculation results, calculated energy supply and demand related information) of the energy supply and demand related information simulation unit 111.

The information processing device 1 in the embodiment may include, for example, a communication device (communication unit) and may be a device that communicates with the user's terminal 20 as an external device.

At least the energy flow diagram may be provided to the terminal 20 by the communication unit.

### <Principle>

Next, the principle of the disclosure will be described.

[Energy supply and demand related information]

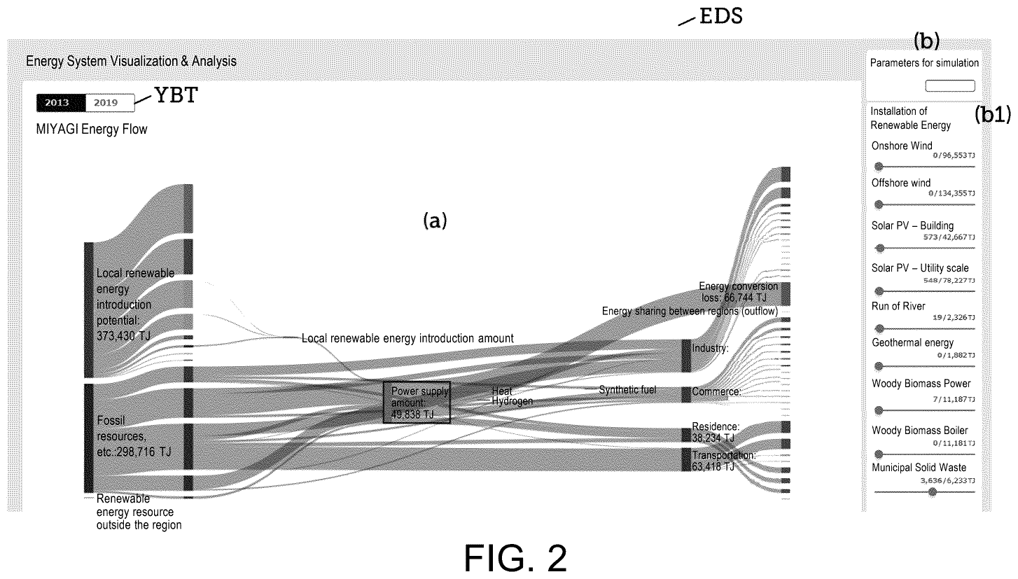

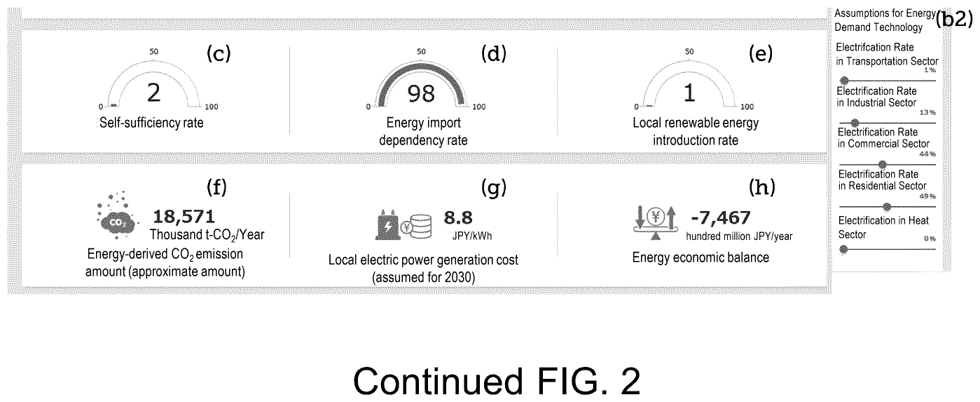

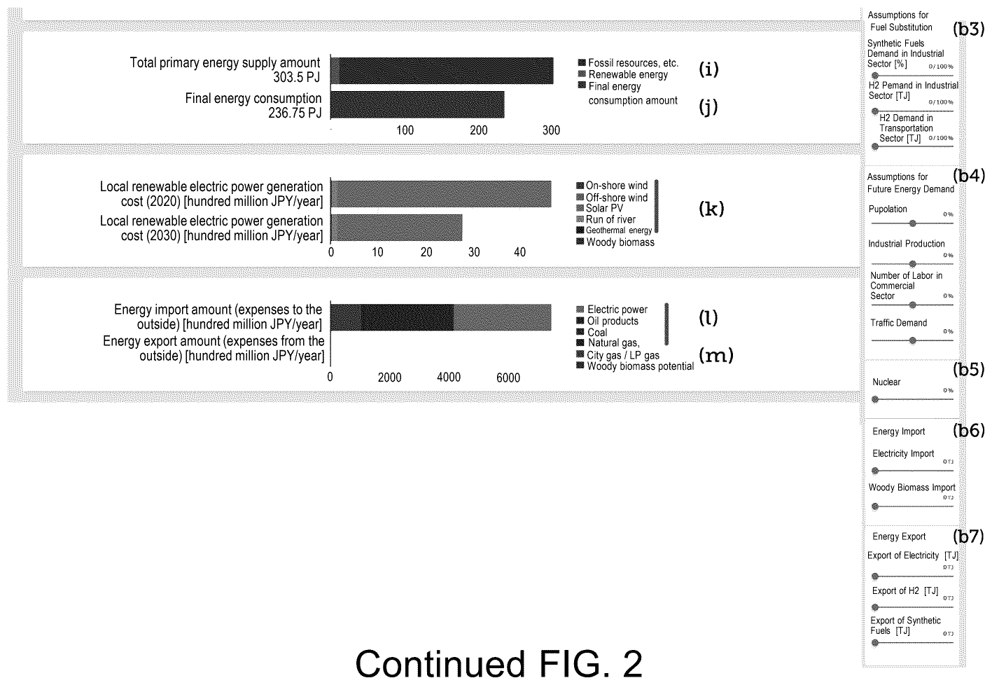

FIG. 2 is a diagram showing an example of an overview of energy supply and demand.

As will be described later in the embodiment, for example, with a user selecting a region (for example, country, prefecture, municipality, etc.) for which the user wants to understand energy supply and demand on his/her own terminal 20, energy supply and demand related information EDS of the selected region can be displayed on the display unit 230 of the terminal 20.

In the example of FIG. 2, based on the selected region being Miyagi Prefecture, the energy supply and demand related information EDS for the entire Miyagi Prefecture is displayed. In the example, data for 2013 selected by the user is displayed, but by selecting a button YBT provided in the upper left part of the screen, it is also possible to display data for other years (for example, data for 2019).

The energy supply and demand related information EDS includes, for example, each of the following information (a) to (m).
(a) Energy flow diagram that visualizes the overall picture of the energy supply and demand structure (energy system) within the region

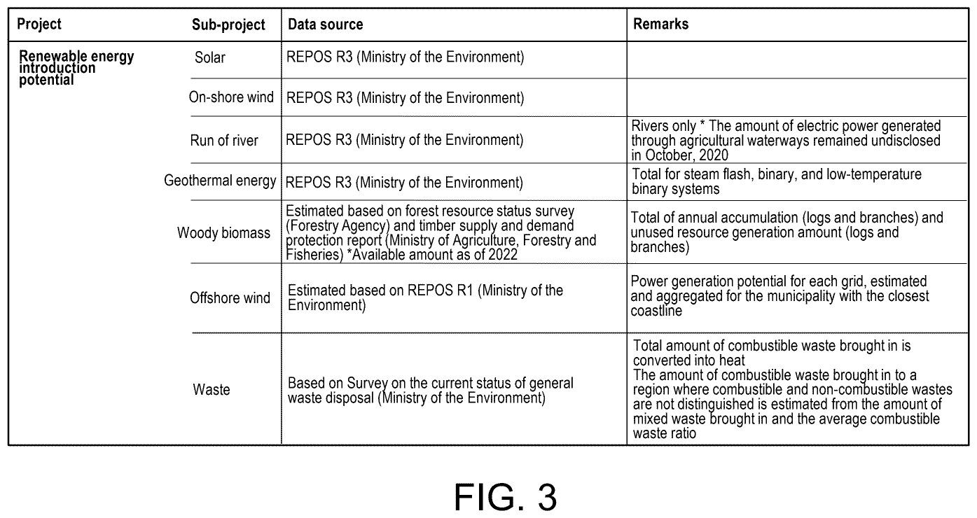

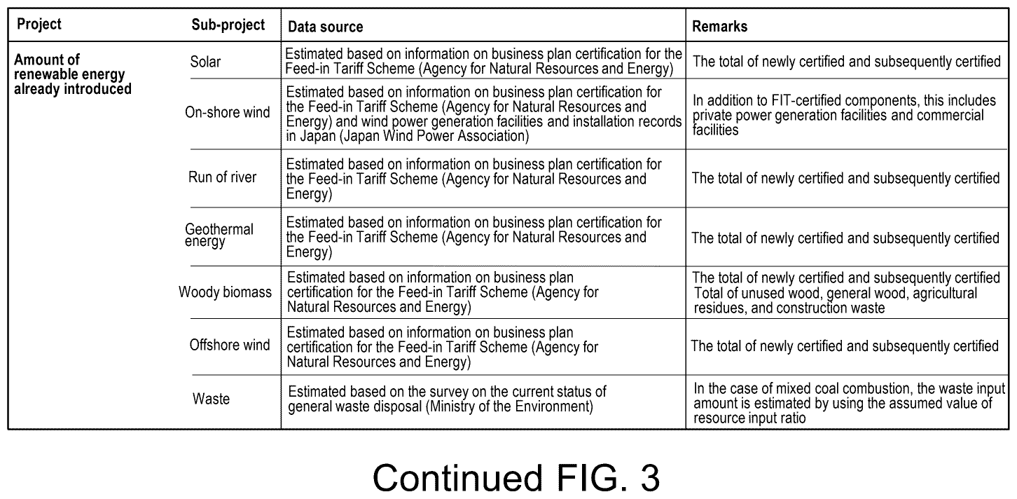

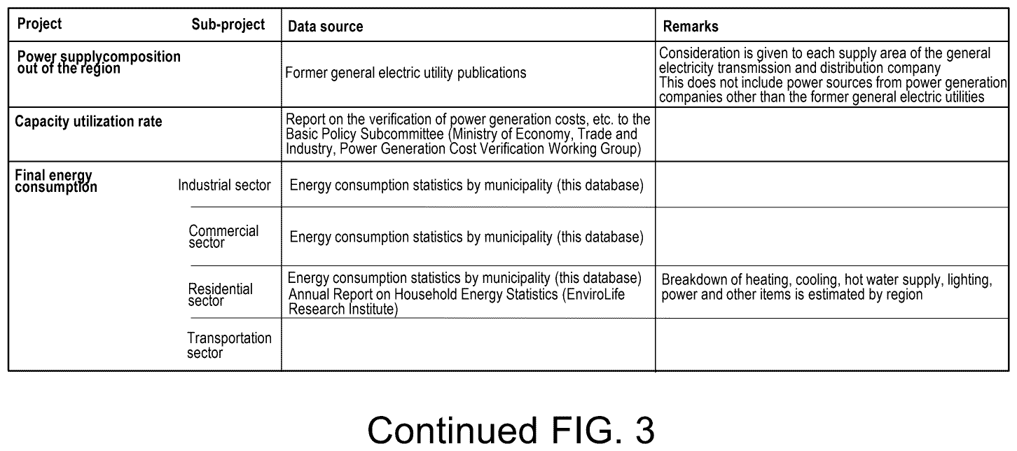

For creating the energy flow diagram, for example, data shown in FIG. 3 is used.

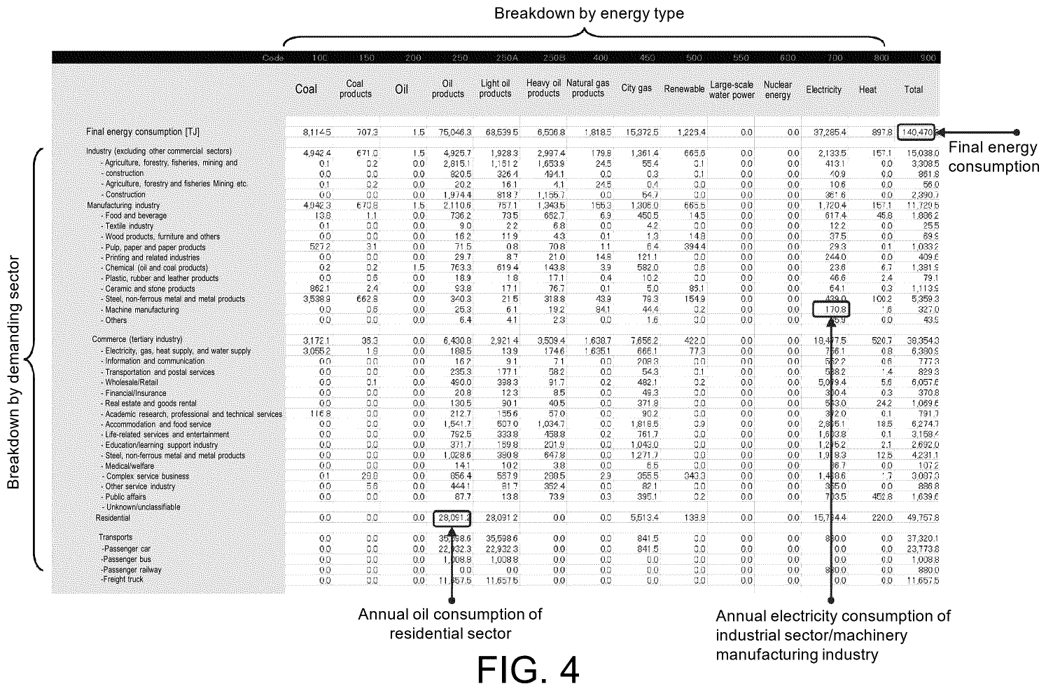

For calculating the final energy consumption (by sector) in FIG. 3, an energy consumption statistics table shown in FIG. 4 is used. The energy consumption statistics table is a table that summarizes annual energy consumption by energy type and demand sector, and enables understanding of which energy type is consumed in which demand sector and in what amount.

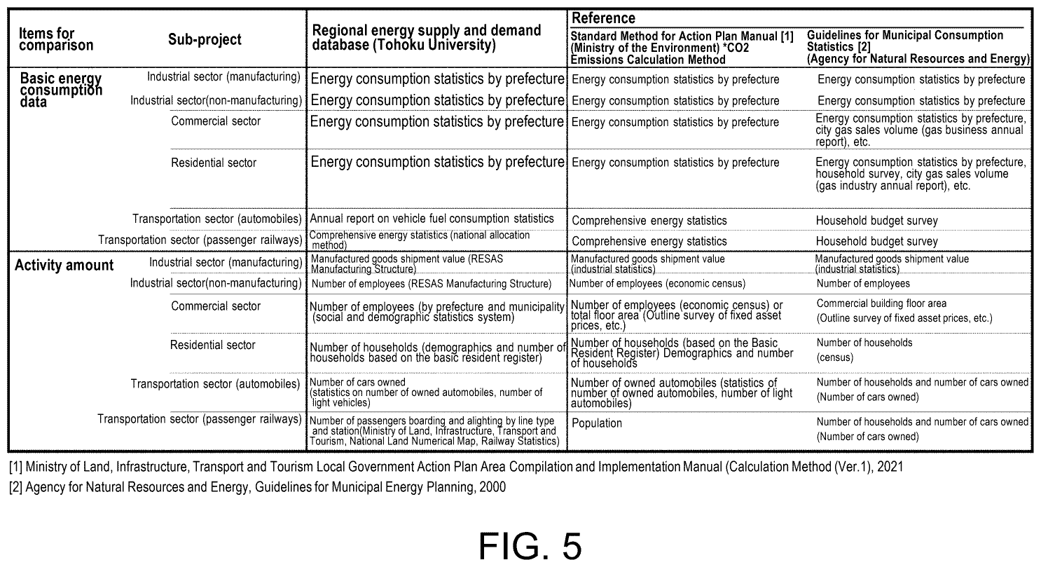

The estimation of energy consumption by municipality is performed by a prefecture-based proportional allocation method based on data shown in FIG. 5.

$$Municipality energy consumption = Prefecture energy consumption \times [ Municipality activity amount / Prefecture activity amount ] \qquad ( Formula 1 )$$

(b) Simulation parameters that are setting conditions (parameters) for generating an energy flow diagram, where initial values are values based on actual measurement data, but can be changed by the user from initial values to other values

Operable parameters, may include the following, for example:
(b1) Renewable energy introduction amount [TJ/year]

Each parameter of onshore wind, offshore wind, solar PV (building system), solar PV (utility scale), run of river, geothermal energy, woody biomass power generation, woody biomass boiler, waste, etc.

Regarding the renewable energy introduction amount of each type, it can also be said to be the energy amount of the type that can be utilized by existing facilities among the renewable energy potentials of the type in the region. Also, the renewable energy introduction amount (introduction rate) of each type may be the ratio of energy amount that can be utilized by existing facilities among the renewable energy potentials of the type in the region, or may be the ratio of existing facilities based on facilities for utilizing all renewable energy potentials in the region.
(b2) Electrification rate by assumed sector of energy consumption

Each parameter of transportation sector electrification rate, industrial sector electrification rate, commercial sector electrification rate, residential sector electrification rate, heat supply electrification rate, etc.
(b3) Fuel substitution rate (assuming hydrogen and synthetic fuel)

Each parameter considering the production of hydrogen and synthetic fuel for decarbonization of hard-to-abate sectors, including each parameter of synthetic fuel substitution rate (industrial sector), hydrogen substitution rate (industrial sector), hydrogen substitution rate (transportation sector), etc.
(b4) Assumed socioeconomic indicator increase/decrease rate of macro frame

Each parameter which considers socioeconomic indicators, and
each parameter of residential sector activity increase/decrease rate (population, etc.), industrial sector activity increase/decrease rate (manufactured goods shipment value, etc.), commercial sector activity increase/decrease rate (number of employees, etc.), transportation sector activity increase/decrease rate (mobility demand, etc.), etc.
(b5) Assumption of grid power (power source composition)

Each parameter of nuclear power ratio, etc.
(b6) Assumed energy transfer import/export [TJ] for inter-regional energy interchange

Each parameter assuming the amount of power interchange from other cooperating regions (for example, other municipalities within the same prefecture), and each parameter of power transfer import/export, woody biomass transfer import/export, etc.
(b7) Energy transfer export

Each parameter of power transfer export amount, hydrogen transfer export amount, synthetic fuel transfer export amount, etc.
(c) Energy self-sufficiency rate, which is the ratio of the amount of energy produced within the region to the amount of energy supplied within the region

Even if the energy self-sufficiency rate is 100%, it does not necessarily mean that all energy demand within the region is covered by energy produced within the region (self-sufficiency is achieved). This is because energy produced within the region may be transferred and exported. The energy self-sufficiency rate is calculated by the following formula.

$$Energy self - sufficient rate [ \% ] = [ Energy production within region [ TJ ] / Energy supply within region [ TJ ] ] \times 100 \qquad ( Formula 2 )$$

(d) Energy import dependency rate, which is the ratio of the amount of energy imported from outside the region to the amount of energy supplied within the region

This is an indicator that shows how much the amount of energy supplied within the region depends on energy import from outside the region, and in the case where the energy import dependency rate is 0%, it can be said that all energy demands within the region are met by the energy produced within the region (self-sufficiency is achieved).

The energy import dependency rate is calculated by the following formula.

$$Energy import dependency rate [ \% ] = [ Energy transfer input amount [ TJ ] / Energy supply within region [ TJ ] ] \times 100 \qquad ( Formula 3 )$$

(e) Local renewable energy introduction rate, which is the ratio of those among the renewable energy potentials within the region that are actually introduced In the case where the local renewable energy introduction rate being 100%, all of the renewable energy potentials is being utilized.
(f) Energy-derived CO₂ emission amount, which is the CO₂ emission amount generated in association with energy conversion or consumption within the region The energy-derived CO₂ emission amount is calculated by the following formula.

$$Energy - derived {CO}_{2} emission amount [ t - {CO}_{2} ] = Primary energy supply amount [ TJ ] \times {CO}_{2} emission amount [ t - {CO}_{2} / TJ ] \qquad ( Formula 4 )$$

(g) Local power generation cost (LCOE: Levelized Cost of Electricity), which is the cost for generating 1 kWh of electricity by using the renewable energy within the region

The local power generation cost is calculated by the following formula.

$$Local power generation cost [ yen / kWh ] = Local renewable energy power generation cost [ yen / year ] / Renewable energy power generation amount [ kWh / year ] \qquad ( Formula 5 )$$

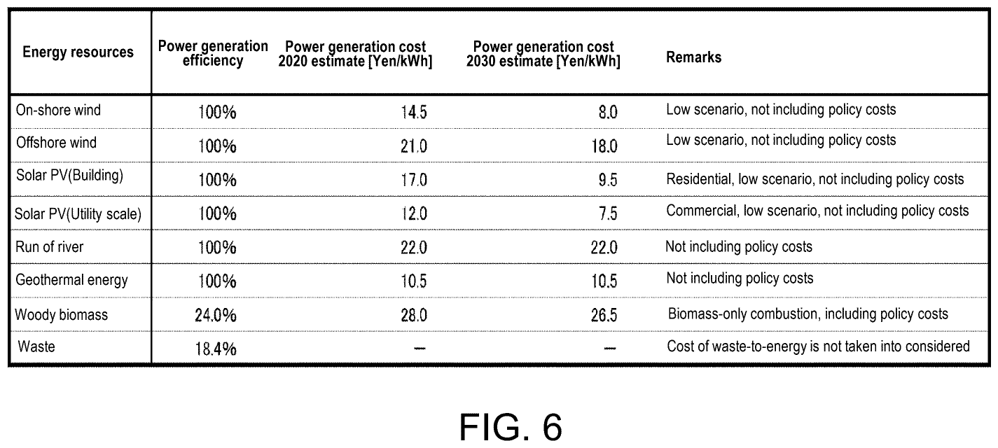

The local power generation cost of each resource (onshore wind power, etc.) as renewable energy is shown in FIG. 6.
(h) Energy economic balance representing the balance of energy payment inflow and outflow associated with energy transfer input and output of the region The energy economic balance is calculated by the following formula.

$$Energy economic balance [ hundred million JPY / year ] = Energy export amount [ hundred million JPY / year ] - Energy import amount [ hundred million JPY / year ] \qquad ( Formula 6 )$$

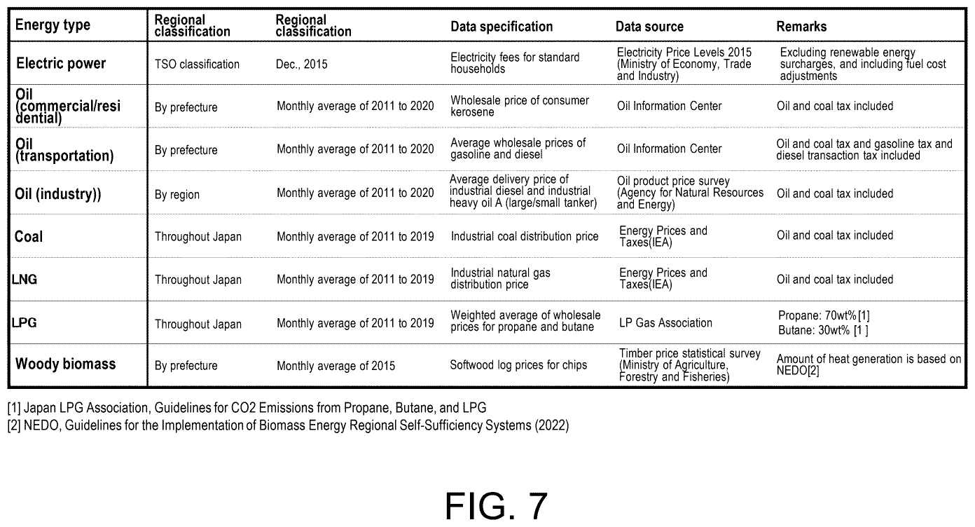

The energy export amount and the energy import amount of each region are obtained from the aggregated data in FIG. 7.
(i) Total primary energy supply (TPES), which is the total of primary energy (energy that has not been converted to secondary energy such as electricity or heat, including coal, oil, natural gas, etc.) supplied within the region

The total primary energy supply is calculated by the following formula.

$$TPES [ TJ ] = Regional energy production amount [ TJ ] + Energy import amount [ TJ ] - Energy export amount [ TJ ] \qquad ( Formula 7 )$$

(j) Final energy consumption (FEC), which is the energy amount consumed by final consumers such as industries and households within the region (does not include energy amount input for energy conversion)

Final energy consumption is calculated by the following formula.

$$FEC [ TJ ] = Fuel consumption amount [ TJ ] + Power consumption amount [ TJ ] + Heat consumption amount [ TJ ] \qquad ( Formula 8 )$$

(k) Local renewable energy power generation cost, which is the total cost required for the renewable energy power generation within the region, including capital costs, operation and maintenance costs, and fuel costs

$$Local renewable energy power generation cost [ JPY / year ] = Power generation efficiency \times Renewable energy introduction amount [ TJ / year ] \times Power generation cost unit price [ JPY / kWh ] \qquad ( Formula 9 )$$

(l) Energy transfer import amount, which is the total amount required for energy transfer and import from outside the region
(m) Energy transfer export amount, which is the total amount obtained from energy supplied to outside the region

Such information is obtained by the aggregated data of FIG. 7.

### [Energy Flow Diagram]

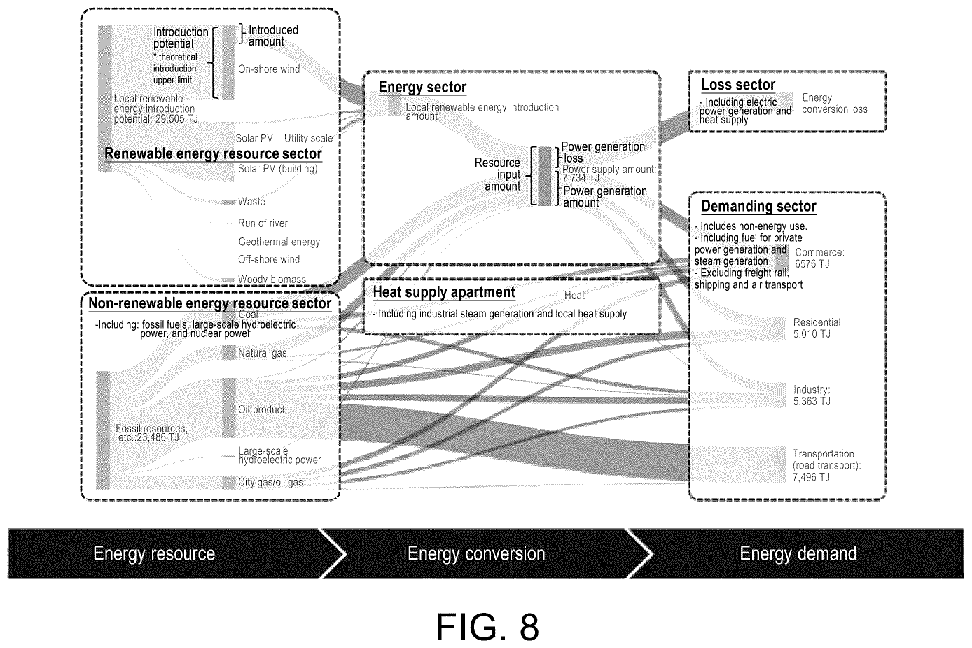

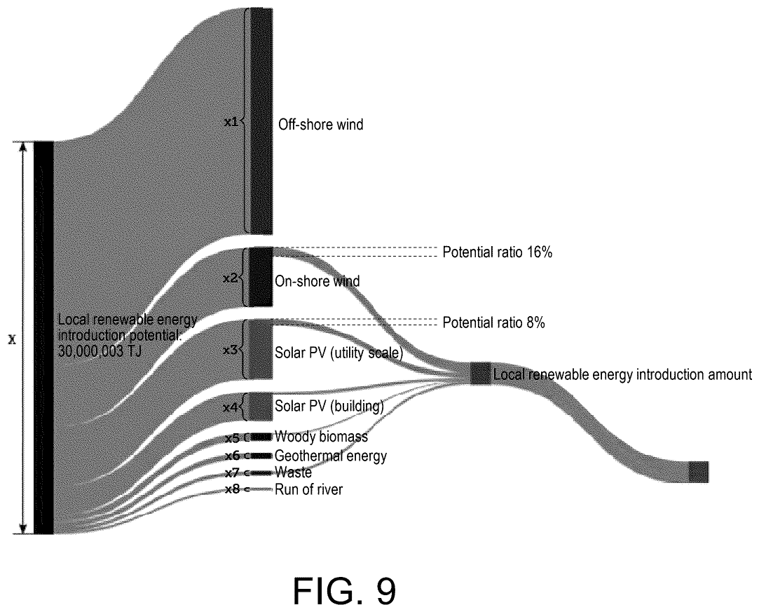

Next, the energy flow diagram of (a) in the present embodiment will be described using FIG. 8 and FIG. 9, etc. As shown in FIG. 8, the energy flow diagram of (a) is broadly divided into three domains, i.e.: energy resource domain (left side of the figure) corresponding to energy resources, energy conversion domain (central part of the figure) corresponding to energy conversion, and energy demand domain (right side of the figure) corresponding to energy demand. By expressing the energy flow rate between each domain (between objects included in each domain) through the width (height) of the flow, the energy balance of each domain is made easy to understand.

The energy resource domain includes objects of the renewable energy resource sector and objects of the non-renewable energy resource sector.

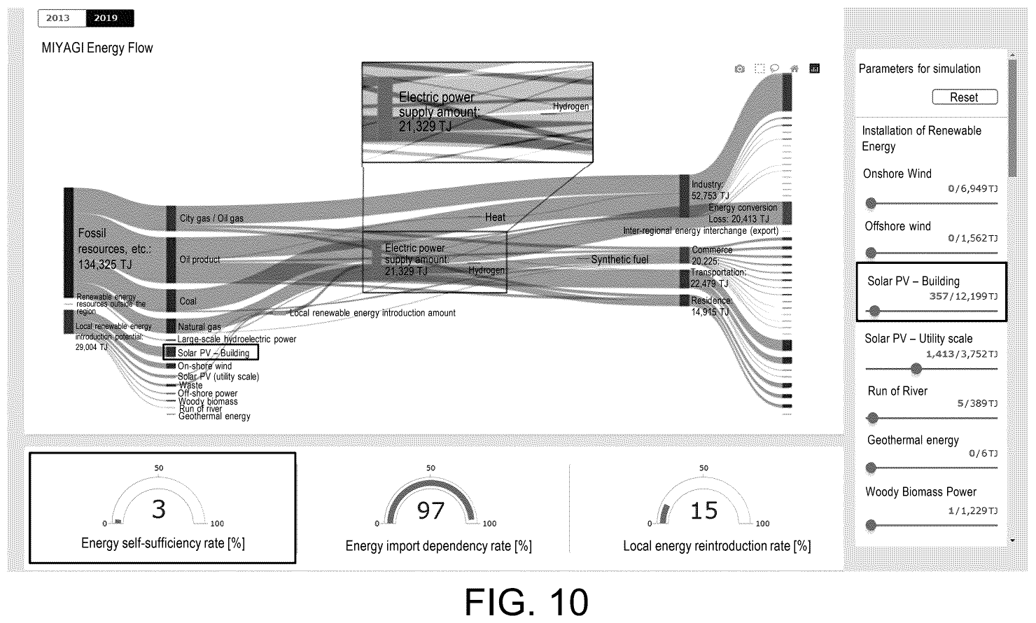

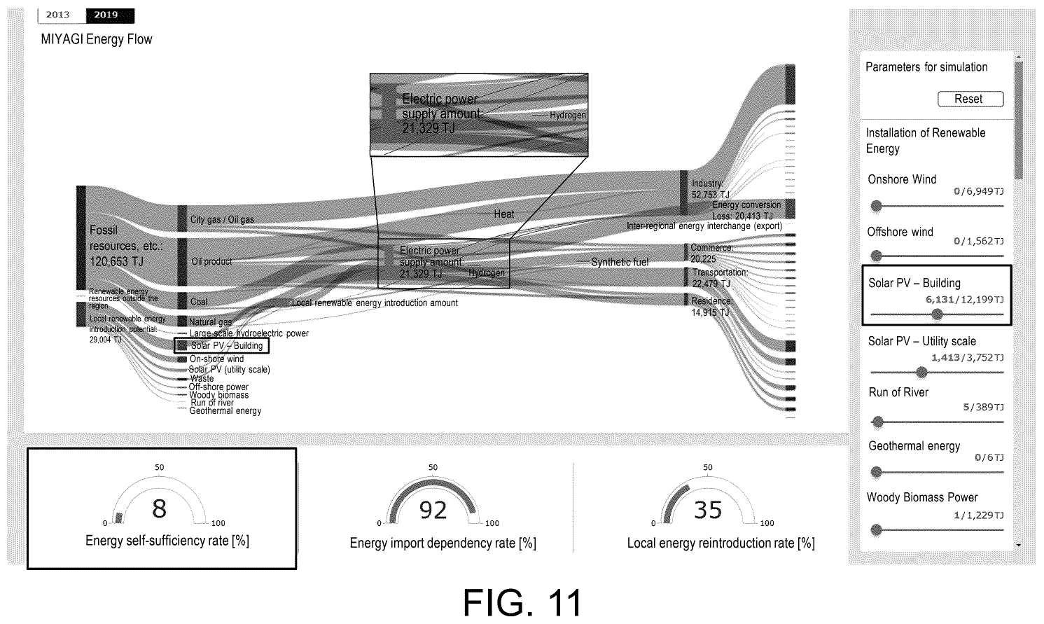

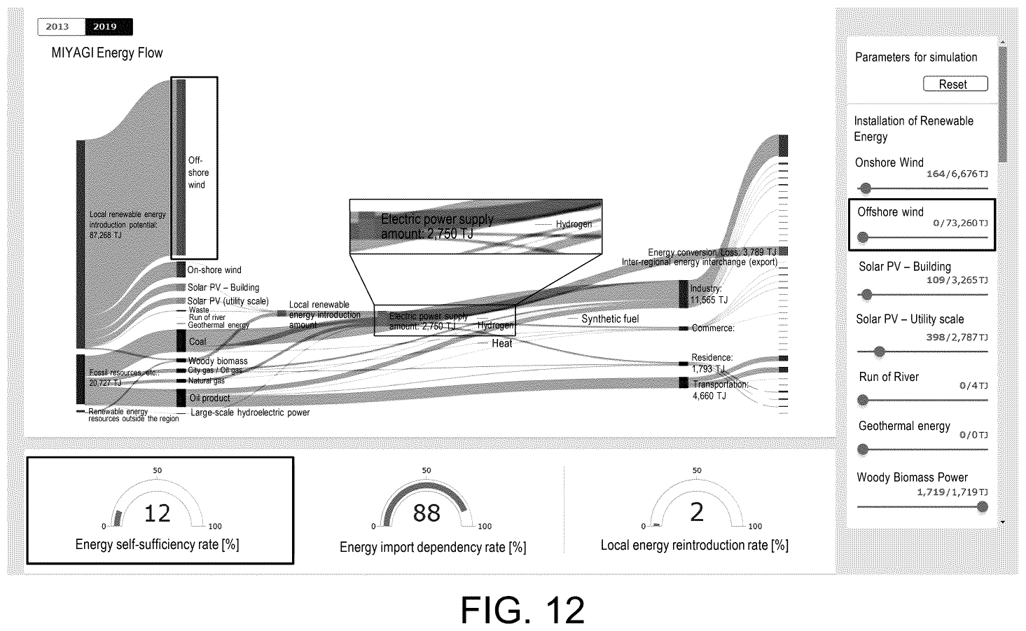

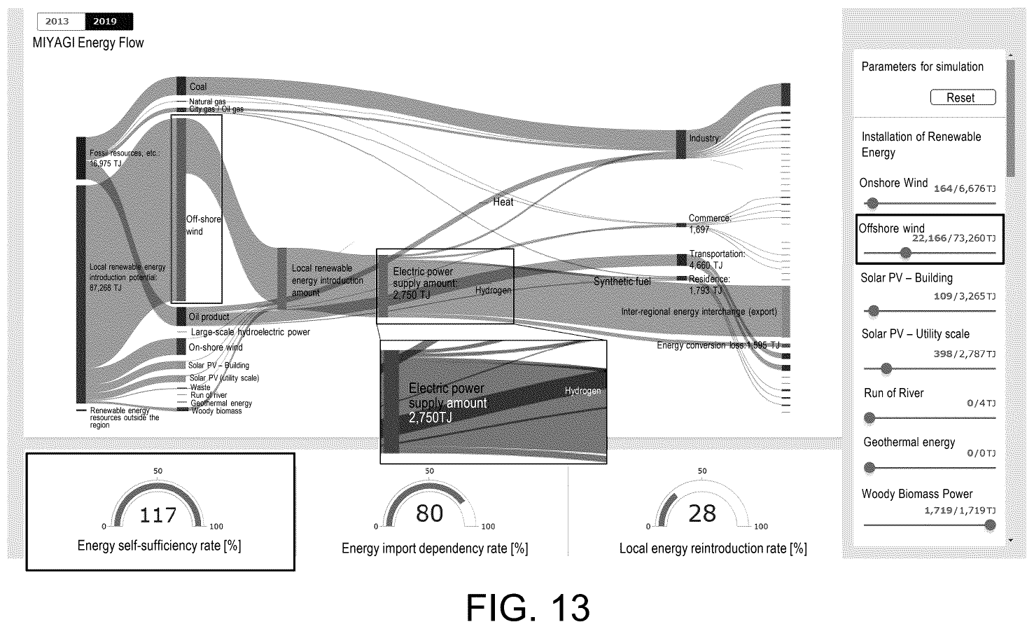

Objects of the renewable energy resource sector can include an object corresponding to the potentials of all the renewable energy resources in the region (hereinafter referred to as “first resource object”) and objects corresponding to the respective types of renewable energy having potential in the region, for example, onshore wind, offshore wind, solar PV (building system), solar PV (utility scale), run of river, geothermal energy, woody biomass power generation, woody biomass boiler, and waste (hereinafter referred to as “second resource objects”) (see also FIG. 10, FIG. 11, FIG. 12, FIG. 13, etc.)

Objects of the non-renewable energy resource sector can include objects corresponding to all the non-renewable energy resources such as fossil resources that are supplied to and used in the region (in most cases imported from outside the region and used), and objects corresponding to the respective types of non-renewable energy, for example, city gas/coal gas, coal, petroleum products, and natural gas (see also FIG. 10, FIG. 11, FIG. 12, FIG. 13, etc.)

Here, as shown in FIG. 9, regarding the renewable energy sector, the height X of the first resource object corresponds to the potentials of all the renewable energy resources in the region, and the height (x1, x2, . . . , xn) of each second resource object corresponds to the potential of each type of the renewable energy resources in the region.

Therefore, in response to summing the heights of each second resource object, it matches the height of the first resource object (X=x1+x2+ . . . +xn).

In the present example, the width (X) of the flow output from the first resource object is the same as the height (X) of the first resource object, and the width (x1, x2, . . . , xn) of the flow input to each second resource object is also the same as the height (x1, x2, . . . , xn) of each second resource object. Based on such premise, the flow output from the first resource object branches and is input to each second resource object.

Therefore, the height of each second resource object (the width of the flow input to the second resource object) shows the potential (theoretical introduction upper limit) of the renewable energy of the type.

On the other hand, since the width of the flow output from the second resource object corresponds to the introduction amount of the type of renewable energy resource in the region (energy resource that can be supplied by existing facilities), the ratio (difference between both) of the width of the flow input to the second resource object (height of the second resource object itself) and the width of the flow output from the second resource object allows visual understanding of how much of the potential is actually introduced regarding the type of renewable energy resource.

In the example of FIG. 9, although offshore wind has the largest potential among the local renewable energy potential, no flow is output from the second resource object (height x1) corresponding to offshore wind. Therefore, although there is offshore wind potential, it is not utilized at all as renewable energy.

On the other hand, a flow is output from the second resource object corresponding to onshore wind, and since the width of the flow is approximately 16% of the height x2 of the second resource object (the width x2 of the flow input to the second resource object), 16% of the onshore wind potential is utilized as renewable energy.

Meanwhile, a flow is also output from the second resource object corresponding to solar PV (utility scale), and since the width of the flow is approximately 8% of the height x3 of the second resource object (the width of the flow input to the second resource object), 8% of the solar PV (utility scale) potential is utilized as renewable energy.

Returning to FIG. 8, the energy conversion domain can include an object of the electric power sector and an object of the heat supply sector.

To the object of the electric power sector, among the flows output from the respective objects in the energy resource domain, flows equivalent to energy that are converted into electric power for the purpose of supplying the demand sectors (including the purpose of hydrogen conversion) are input. Since the height of the object of the electric power sector matches the total width of the input flows and matches the total width of the branched flows that are output, it is easy to understand how much of the input energy resources is converted into electric power and supplied to the demand sectors, or become a power generation loss (see also FIG. 10, FIG. 11, FIG. 12, FIG. 13, etc.)

To the object of the heat supply sector, among the flows output from the respective objects in the energy resource domain, flows equivalent to energy that is converted into heat for the purpose of supply to demand sectors (including industrial steam generation and local heat supply) are input.

Since the height of the object of the heat supply sector matches the total width of the input flows and also matches the total width of the output and branched flows, it is easy to understand how much of the input energy resources are converted into heat and supplied to demand sectors, or become heat supply losses (see also FIG. 10, FIG. 11, FIG. 12, FIG. 13, etc.)

According to the embodiment, among the energy amount supplied from the energy resource domain, the amount (ratio) converted to electric power and the amount (ratio) converted to heat can be respectively understood, and the loss (ratio) associated with power conversion and the loss (ratio) associated with heat conversion can also be respectively understood.

Here, in the embodiment, the object of the heat supply sector is arranged on the demand sector side relative to the object of the electric power sector. Accordingly, in the case where energy is present in the region that is supplied to the demand sectors through heat conversion after power conversion, this can be expressed by flows output from the object of the electric power sector and input to the object of the heat supply sector. In other words, by adopting such an arrangement, even under the constraint that flows proceed only in the forward direction (from supply side to demand side) and do not proceed in the reverse direction (from demand side to supply side) as in the present embodiment, multiple patterns of heat conversion can be appropriately expressed.

In this way, regarding the object of the heat supply sector, at least one of a flow that is output from the energy resource domain and input directly to the object of the heat supply sector without passing through the object of the electric power sector and a flow that is output from the energy resource domain and input to the object of the heat supply sector after passing through the object of the electric power sector can be input.

The energy demand domain can include an object of a loss sector and an object of a demand sector.

Among the flows output from the electric power sector, a flow equivalent to the conversion loss is branched and input to the object of the loss sector, and, among the flows output from the object of the heat supply sector, a flow equivalent to the conversion loss is branched and input (see also FIG. 10, FIG. 11, FIG. 12, FIG. 13, etc.)

Since the height of the object of the loss sector (energy conversion loss object) matches the total width of the input flows (equivalent to the power generation loss, equivalent to the heat conversion loss), it is easy to understand how the energy much becomes loss without being used for final demand during the energy conversion process.

The object of the demand sector can include an object corresponding to the industrial demand (including non-energy use such as petroleum product applications), an object corresponding to the commercial demand, an object corresponding to the transportation demand (excluding freight railways, ships, and aviation), and an object corresponding to the residential demand (see also FIG. 10, FIG. 11, FIG. 12, FIG. 13, etc.) Private power generation and use as fuel for steam generation can also be included in the object of the demand sector.

Regarding the industrial demand, examples may include an object corresponding to the entire industrial sector (an example of the first demand object) and an object corresponding to each industry (for example, chemical industry (including petroleum and coal products), construction industry, etc.) (an example of the second demand object).

Regarding the commercial demand, examples may include an object corresponding to the entire commercial sector (an example of the first demand object) and an object corresponding to each commercial activity (for example, wholesale and retail trade, accommodation and food service activities, etc.) (an example of the second demand object).

Regarding the transportation demand, examples may include an object corresponding to the entire transportation sector (an example of the first demand object) and an object corresponding to each transportation means (for example, passenger cars, freight vehicles, etc.) (an example of a second demand object).

Regarding the residential demand, examples may include an object corresponding to the entire residential sector (an example of the first demand object) and an object corresponding to each application (for example, heating, cooling, hot water supply, etc.) (an example of the second demand object).

For each of the industrial demand, the commercial demand, the transportation demand, and the residential demand, the height of the first demand object matches the total of the heights of the second demand objects.

Also, the total width of the flows input to the first demand object matches the height of the first demand object, and also matches the total of the widths of the flows output from the first demand object and branching to the second demand objects. The width of each flow after branching matches the height of the second demand object to which the flow is input.

Through such relationships, it is easy to visually understand how much energy is consumed for the industrial demand, the commercial demand, the transportation demand, and the residential demand respectively, and for each demand, what applications consume how much energy.

### [Comparison of Energy Flow Diagrams]

By using the energy flow diagrams of FIG. 10, FIG. 11, FIG. 12, and FIG. 13, comparison examples under different conditions within the same region and comparison examples between different regions (between different municipalities within the same prefecture) are described.

FIG. 10 is an energy flow diagram for Sendai City, Miyagi Prefecture.

The height of the first resource object showing the potential of local renewable energy resources is approximately 22% of the height of the object corresponding to the supply amount of the non-renewable energy resources (fossil resources, etc.), and the energy self-sufficiency rate is only 3%.

Therefore, it is understood that even if the potential of local renewable energy resources can be utilized to the maximum extent, the contribution to the energy self-sufficiency rate may be limited.

For example, the local renewable energy resource with the maximum potential in the region is solar PV (building system), but the introduction rate as of 2019 is approximately 29% (equivalent to the initial value of the simulation parameter).

Here, as shown in FIG. 11, in the case where the simulation parameter is operated to raise the introduction rate of solar PV (building system) to approximately 50%, the width of the flow output from the second resource object of solar PV (building system) changes to approximately 50% of the second resource object, and the energy self-sufficiency rate increases from 3% to 8%.

The energy import dependency rate decreases from 97% to 92%, and the local renewable energy introduction rate increases from 15% to 35%.

FIG. 12 is an energy flow diagram for Ishinomaki City, Miyagi Prefecture in 2019. Unlike the example of Sendai City, although the height of the first resource object showing the potential of local renewable energy resources is 420% of the height of the object corresponding to the supply amount of non-renewable energy resources, the energy self-sufficiency rate remains at only 12%. Therefore, it is understood that the effect of improving the self-sufficiency rate by introducing non-renewable energy resources is significant.

For example, the local renewable energy resource with the maximum potential in the region is offshore wind, but the introduction rate as of 2019 is approximately 0% (equivalent to the initial value of the simulation parameter).

As shown in FIG. 13, in the case where the simulation parameter is operated to raise the introduction rate of offshore wind to approximately 30%, the width of the flow output from the second resource object of offshore wind changes to approximately 30% of the second resource object, and the energy self-sufficiency rate increases from 12% to 117%.

In the example of FIG. 13, much of the increased energy self-sufficiency rate may be used for inter-regional energy interchange (export), such as supplying to different municipalities within the same prefecture.

The energy import dependency rate decreases from 88% to 80%, and the local renewable energy introduction rate increases from 2% to 28%.

In this way, by operating the simulation parameter (changing from initial values), it is possible to change the energy flow diagram generated based on actual statistical data to an energy flow diagram based on hypothetical data.

For example, it is possible to understand how the energy flow diagram or the energy self-sufficiency rate changes, etc., according to what condition settings are made within a certain region, and this can be utilized for the energy policy of such region.

Also, for example, by comparing the potentials of local renewable energy resources between neighboring regions within the same prefecture, for example, it is also possible to make plans for inter-regional energy interchange where the renewable energy generated in one region with a relatively large potential is supplied to the other region with a relatively small potential.

In the energy flow diagram of the embodiment, in principle, the width of the flow input to an object (the sum of the respective widths in the case where multiple flows are input) and/or the width of the flow output from an object (the sum of the respective widths in the case where multiple flows are output) matches the height of the object. Therefore, in each of the energy resource domain, the energy conversion domain, and the energy demand domain, it is easy to understand at a glance the relationships between the respective set items, the energy inflow path and/or the outflow path for each item, and the inflow energy amount and/or the outflow energy amount for each item.

However, regarding the second resource object, the height of the second resource object (the width of the flow input to the second resource object) represents the potential of the non-renewable energy resource of the type, and the width of the flow output from the second resource object (the sum of the respective widths in the case where multiple flows are output) represents the non-renewable energy of the type that is actually introduced.

Therefore, in accordance with the relationship (for example, the ratio of the latter to the former) between the height of the second resource object and the width of the flow output from the second resource object, it is easy to understand how much of the potential is utilized, and the portion of the height of the second resource object from which no flow is output can be easily recognized as the room for improvement (room for improving the energy self-sufficiency rate).

Also, in the energy flow diagram of the embodiment, in the energy resource domain, the first resource object and the objects corresponding to the all the non-renewable energy resources such as fossil resources are arranged in a vertical column, and each second resource object and the objects respectively corresponding to the non-renewable energy resources of city gas/coal gas, coal, petroleum products, and natural gas are arranged in a vertical column. Accordingly, it is easy to compare the flow input source and/or output destination, as well as the flow width, between objects of the same level arranged in the upper-lower direction.

Also, in the energy demand domain, the respective first demand objects are arranged in a vertical column, and the respective second demand objects are arranged in a vertical column. Accordingly, it is easy to compare the input source and/or the output destination of the flow, as well as the flow width, between objects of the same level arranged in the upper-lower direction.

### [Hydrogen Object]

In the embodiment, as shown in the energy flow diagrams of FIG. 10, FIG. 11, FIG. 12, and FIG. 13, a hydrogen object corresponding to the energy equivalent to hydrogen conversion is arranged on the downstream side (demand side) of the electric power sector object in the energy conversion domain.

The width of the flow input to the hydrogen object (the height of the hydrogen object) is the hydrogen conversion equivalent of the power (energy amount) corresponding to the width (height of the electric power sector object) of the flow output from the electric power sector object. Among the flows output from the electric power sector object, a branched portion (hydrogen conversion equivalent) is input to the hydrogen object, and the flow output from the hydrogen object branches and is input to each demand object in the energy demand domain (object of an item that consumes hydrogen-derived energy).

The flow equivalent to the power lost during hydrogen conversion is input to the loss sector object.

Here, by performing the operation to increase the hydrogen substitution rate (industrial sector) or the hydrogen substitution rate (transportation sector) as the simulation parameter, it seems to be expected that the energy-derived CO₂ emission amount in the region may significantly decrease.

However, in practice, unless hydrogen substitution is performed based on renewable energy resources, it does not contribute to the effect of CO₂ reduction, and rather, the use of fossil fuels may result in an increase in energy-derived CO₂ emission amount. That is, if the potential for the renewable energy cannot be expected, the effect of hydrogen substitution in the region is limited.

Therefore, in the embodiment, by calculating the energy-derived CO₂ emission amount based on the width of the non-renewable energy resource flow input to the electric power sector object before hydrogen conversion (the portion derived from non-renewable energy resources among the power before hydrogen conversion) and the width of the renewable energy resource flow (the portion derived from renewable energy resources among the power before hydrogen conversion), a simulation that conforms to reality is realized.

In the case where an operation to increase the hydrogen substitution rate is performed, non-renewable energy resources may be increased as the energy supply source corresponding to the increase. This reflects the reality that even if the hydrogen substitution rate is simply increased without improving the introduction rate (supply capacity) of renewable energy resources, the increase must depend on fossil fuels and the like. However, in the case where the supply capacity of renewable energy resources is greater than the demand for renewable energy resources, the renewable energy resources may be increased as the energy supply source corresponding to the increase.

The operation of the simulation parameter may be an operation to change items related to the simulation parameter by using an absolute value (for example, energy amount), or may be an operation to change the items by using relative values (for example, ratios such as the introduction rate).

### <Processing>

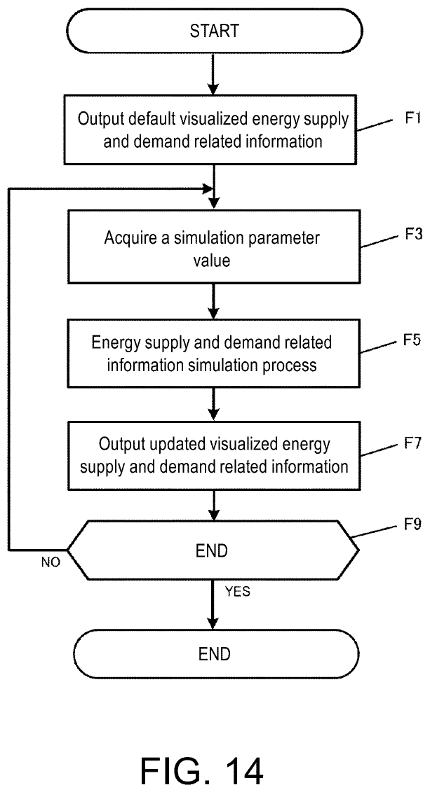

FIG. 14 is a flowchart showing an example of the flow of processing executed by the control unit 11 of the information processing device 1 in the embodiment.

First, the control unit 11 outputs default (values based on actual statistical values) visualized energy supply and demand related information based on default energy supply and demand related information (F1). The default energy supply and demand related information may be output.

Next, the control unit 11 acquires the simulation parameter values input by the user (F3). The acquisition may include an input unit via an input unit of the information processing device 1, reception via a communication unit, and the like.

After that, the energy supply and demand related information simulation unit 111 performs an energy supply and demand related information simulation process to calculate energy supply and demand related information based on the acquired simulation parameter values and the data stored in the energy supply and demand related information calculation database 193 stored in the storage unit 19 (F5).

In addition, the control unit 11 outputs the visualized energy supply and demand related information (F7) based on the energy supply and demand related information calculated (updated) in step F5. The calculated energy supply and demand related information may be output.

After that, the control unit 11 determines whether to end the process (F9).

If it is determined to continue the process (F9:NO), the control unit 11 causes the process to return to step F3, for example.

If it is determined to end the process (F9:YES), the control unit 11 ends the process.

### Effects of Embodiment

According to the embodiment, it is possible to make it easier to understand the relationship between energy supply and energy demand for each region.

Specifically, with the user of a terminal specifying the region (for example, a municipality, etc.) for which an energy flow diagram is to be generated on the terminal, an energy flow diagram of the region is generated in the information processing device and provided to the terminal. As the objects arranged in the energy resource domain of the energy flow diagram, there are the first resource object corresponding to the potential of all the renewable energy resources in the region, and one or more second resource objects respectively corresponding to one or more types of the renewable energy resources having potentials in the region. Since the flow output from the first resource object branches and is input to the one or more second resource objects, the user can easily understand what kind of renewable energy potential is present in the region. Also, for example, it is possible to understand the relationship between energy supply and energy demand considering renewable energy resources in a certain region (country, prefecture, municipality, etc.) and understand the changes in energy self-sufficiency rate accompanying the use of renewable energy resources.

Also, according to the embodiment, the user can understand the potentials of all the renewable energy resources in the specified region by using the height of the first resource object, and can understand the potentials of the respective types of the renewable energy resources in the specified region by using the heights of the respective one or more second resource objects. Also, by relatively comparing the height of the first resource object and the heights of the second resource objects, it is possible to easily understand which type of energy is promising as the renewable energy in the region (whether there is room for introduction).

Also, according to the embodiment, the potentials of all the renewable energy resources in the specified region can be understood not only by using the first resource object but also the width of the flow output from the first resource object, and the potentials of the renewable energy resources for the respective types in the specified region can be understood not only by the second resource objects but also by the widths of the flows input to the second resource objects. Also, by relatively comparing the width of the flow output from the first resource object and the widths of the flows input to the second resource objects, it is possible to easily understand which type of energy is promising as the renewable energy in the region (whether there is room for introduction).

Also, according to the embodiment, by comparing the height of the second resource object and the width of the flow output from the second resource object, it is possible to easily understand how much of the potential of the type of renewable energy corresponding to the second resource object is actually available through existing facilities.

Also, according to the embodiment, the apparent introduction rate of facilities for utilizing the type of renewable energy corresponding to the second resource object can be changed through the operation of the user on the terminal, and the change results can also be reflected in the energy flow diagram displayed on the terminal, so the relationship between capital investment and the results can be easily understood through simulation.

Also, according to the embodiment, by displaying the energy flow diagram and the energy self-sufficiency rate of the region specified by the user in association with each other on the terminal, the user can understand the details of the energy supply and demand in the region. Also, with the user changing the apparent introduction rate of the facilities for utilizing renewable energy, the change results can be reflected in the energy flow diagram and the energy self-sufficiency rate displayed on the terminal, so the relationship between the capital investment and the results thereof can be easily understood through simulation.

Also, according to the embodiment, the energy conversion domain includes an electric power sector object having a height corresponding to the total electric power of the electric power based on the non-renewable energy resources and the power based on the renewable energy resources, and a hydrogen object having a height corresponding to the energy equivalent to hydrogen conversion of the total electric power, a flow having a width equivalent to hydrogen conversion is input from the electric power sector object to the hydrogen object and, flows having widths equivalent to respective demands are input from the hydrogen object to each demand object in the energy demand domain (each item that consumes hydrogen-derived energy), thereby making it possible to understand how much of the power-converted energy is hydrogen-converted and how much the energy is consumed for what purposes.

Also, according to the embodiment, since the energy-derived CO₂ emission amount of the specified region is calculated based not only on the hydrogen substitution rate of the region but also the electric power converted from the non-renewable energy resources and the electric power converted from renewable energy resources, it is possible to appropriately reflect the energy resources that serve as the basis for the hydrogen substitution rate in the region and achieve a CO₂ reduction effect accompanying changes in the hydrogen substitution rate.

Also, according to the embodiment, in the energy conversion domain, since the heat sector object is positioned closer to the demand side than the electric power sector object, multiple patterns of heat conversion can be appropriately expressed even under the constraint that a flow proceeds only in the forward direction and does not proceed in the reverse direction.

### <Specific Configuration (Application Example)>

As a specific configuration (application example) that realizes the content described with the above principle, for example, any of the following may be applied.
(1) Standalone
(2) Client-server system

(1) In the standalone configuration, for example, the information processing device 1 may be a general personal computer or a management computer. In this case, the information processing device 1 may be installed at a predetermined location by a service provider so that a general user can freely use the information processing device 1.

In such case, a general user operates the information processing device 1 to input simulation parameters and the like. Then, the control unit 11 of the information processing device 1 can, for example, display a visualization of the energy supply and demand related information on the display unit of the information processing device 1.

In such configuration, for example, information such as visualized energy supply and demand related information may be transmitted from the information processing device 1 to the user's terminal.

(2) In the client-server system configuration, for example, a system that realizes the above content can be configured by using the information processing device 1 as a server and having the server communicate with the user's terminal. The embodiment will be described below.

### EMBODIMENT

An embodiment to which the above content is applied will be described.

In the embodiment, a client-server system including a server 10 and a user's terminal 20 is exemplified.

However, embodiments to which the disclosure is applicable are not limited to the embodiment described below.

System configuration•Server configuration

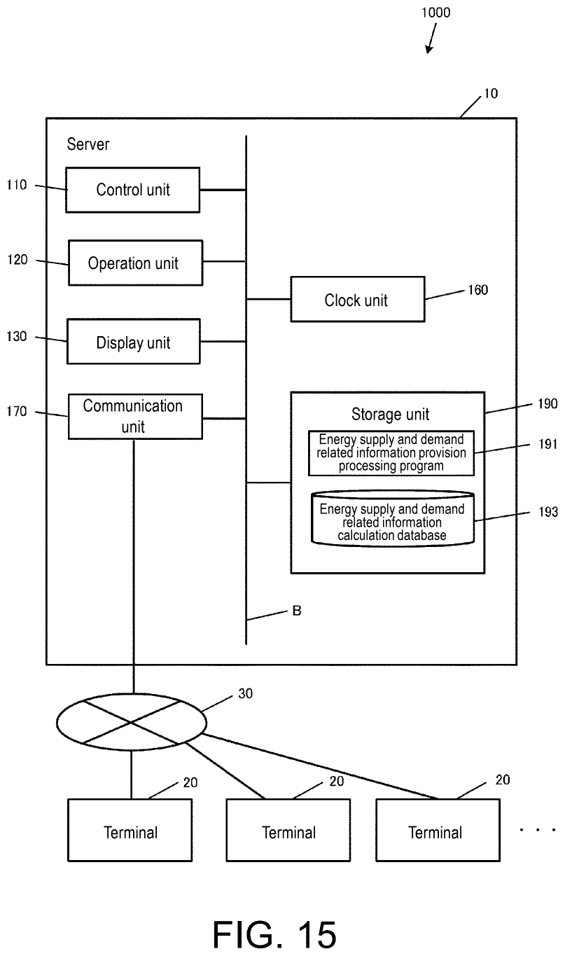

FIG. 15 is a diagram showing an example of the configuration of a system 1000 and the configuration of the server 10 in the embodiment.

The system 1000 is configured so that, for example, the server 10 and multiple terminals 20 (terminals 20 of multiple users) are communicatively connected via a network 30.

The server 10 may include, for example, an information processing device such as a server device, a computer (for example, a desktop, a laptop, a tablet, etc.) However, the above are merely examples.

The terminal 20 may include, for example, an information processing terminal such as a mobile phone, including a smartphone, a computer (as non-limiting examples, a desktop, a laptop, a tablet, etc.), a personal digital assistant (PDA), etc. However, these are merely examples.

The server 10 may be divided into multiple servers, and a server system formed by the servers may be used as a component of the system 1000.

The server 10 includes, for example, a control unit 110, an operation unit 120, a display unit 130, the clock unit 160, a communication unit 170, and a storage unit 190, which are connected via a bus B.

The control unit 110 is a control device (processing device) that comprehensively controls each unit of the own device according to various programs such as system programs, etc., stored in the storage unit 190 and performs various processing, and is configured to have processing circuits such as CPU, GPU, DSP, ASIC, FPGA, etc., for example.

The operation unit 120 is configured to have an input device such as an operation button and an operation switch for the user of the server 100 to perform various operation inputs to the device, for example.

The display unit 130 is a display device configured to have, for example, a liquid crystal display (LCD) or an organic electro-luminescence display (OLED), etc., and performs various displays based on a display signal output from the control unit 110.

The clock unit 160 is a built-in clock and outputs time information (timekeeping information). The clock unit 160 may be configured to have, for example, a clock using a crystal oscillator, etc.

The clock unit 160 may be configured to have a clock that applies the network identity and time zone (NITZ) standard, etc.

The communication unit 170 is a communication device for transmitting and receiving information used inside the device with an external device. As the communication method for the communication unit 170, various methods can be applied, such as a format for wired connection via a cable compliant with a predetermined communication standard such as Ethernet or USB (Universal Serial Bus), a format for wireless connection using wireless communication technology compliant with predetermined communication standards such as Wi-Fi (registered trademark) or 5G (5th generation mobile communication system), and a format for connection using short-range wireless communication such as Bluetooth (registered trademark).

In the embodiment, the server 10 is configured to be capable of communicating with multiple terminals 20 via the network 30.

The storage unit 190 is a storage device configured to have a volatile or non-volatile memory such as ROM, EEPROM, flash ROM, RAM, etc., or an external storage device such as a hard disk, etc.

In the embodiment, the storage unit 190 stores, for example, an energy supply and demand related information provision processing program 191 that is read by the control unit 110 and executed as an energy supply and demand related information provision process, and an energy supply and demand related information calculation database 193. Additionally, the storage unit 190 may store calculated energy supply and demand related information and information for visualizing the same.

### (2) Configuration of Terminal

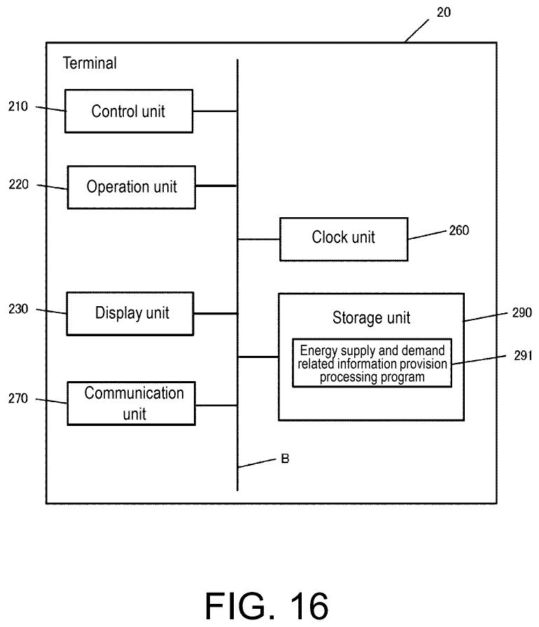

FIG. 16 is a diagram showing an example of the configuration of the terminal 20 in the embodiment.

The terminal 20 includes, for example, a control unit 210, an operation unit 220, a display unit 230, a clock unit 260, a communication unit 270, and a storage unit 290, which are connected via a bus B.

The HW configurations of the control unit 210, operation unit 220, display unit 230, clock unit 260, communication unit 270, storage unit 290, etc., may be the same as the server 10.

The operation unit 220 may have, for example, a touch panel configured integrally with the display unit 230, and the touch panel may function as an input interface between the user and the terminal 20. Additionally, the display unit 230 may be configured integrally with the touch panel to form a touch screen.

In the embodiment, the storage unit 290 stores, for example, an energy supply and demand related information acquisition and display processing program 291 that is read by the control unit 210 and executed as an energy supply and demand related information acquisition and display process.

The energy supply and demand related information acquisition and display processing program 291 may be configured, for example, as an application (application program).

The application may be a web application, a native application, or a hybrid application.

### <Processing>

In the embodiment, for example, based on the process shown in FIG. 14, the control unit 210 of the terminal 20 requests energy supply and demand related information for a specified year of a specified region from the server 10 by using the communication unit 270, based on a user input that specifies a region (for example, country, prefecture, municipality, etc.) and year for which the user wants to understand energy supply and demand, etc., via the operation unit 220.

The control unit 110 of the server 10 transmits default visualization energy supply and demand related information to the terminal 20 via the communication unit 270 based on the request of the terminal 20 received by the communication unit 270 (F1).

Then, the control unit 210 of the terminal 20 causes the display unit 230 to display the received visualization energy supply and demand related information.

Next, the control unit 210 of the terminal 20 transmits the simulation parameter values to the server 10 via the communication unit 270 based on the user input of the simulation parameter values via the operation unit.

The control unit 110 of the server 10 receives the simulation parameter values from the terminal 20 via the communication unit 170 (F3), and performs an energy supply and demand related information simulation process based on the received simulation parameter values (F5).

Next, the control unit 110 of the server 10 transmits information such as visualization energy supply and demand related information to the terminal 20 via the communication unit 170 (F7).

Then, the control unit 210 of the terminal 20 causes the display unit 230 to display the visualization energy supply and demand related information.

Also, the control unit 110 of the server 10 may cause the storage unit 190 to store time information (or date and time information) at which a request is made from the terminal 20 for each region in association with the region, based on the output from the clock unit 160. The information stored in this manner may be used for statistical processing (such as at what timing, which region's energy supply and demand related information is requested and to what extent, etc.) The same may apply to fiscal years.

The control unit 210 of the terminal 20 may perform a similar process.

In the embodiment, when a user specifies a region and fiscal year, the energy supply and demand related information based on actual statistical values (which may also be called aggregated values) of the specified region for the specified fiscal year can be transmitted from the server 10 to the terminal 20 and displayed.

Also, with the user operating the simulation parameters, the energy supply and demand related information based on hypothetical data can be recalculated by the server 10, transmitted from the server 10 to the terminal 20, and displayed.

### Others

The terminal 20 may perform at least portion of the process performed by the server 10 described in the above example.

Also, the information processing device 1 of the disclosure may be various information processing terminals including the user's terminal 20.

Also, in the above embodiment, a method of implementing the disclosure by a client-server system is exemplified, but in addition to this, a system may be realized that provides the server functions to terminals (which may also be called a distributed system). This may be implemented by using, for example, the blockchain technology.

1. An information processing device, communicating with a terminal, the information processing device comprising:
a control unit, generating an energy flow diagram that indicates a relationship between energy supply and energy demand related to a region specified by a user of the terminal based on data of the region; and
a communication unit, providing the energy flow diagram to the terminal,
wherein the energy flow diagram comprises: an object arranged in each of an energy resource domain, an energy conversion domain, and an energy demand domain; and a flow from the energy resource domain toward the energy demand domain via the energy conversion domain,
the object arranged in the energy resource domain comprises: a first resource object corresponding to potentials of all renewable energy resources in the region; and one or more second resource objects, respectively corresponding to one or more types of renewable energy resources having potentials in the region,
wherein the flow output from the first resource object is input to the second resource object.

2. The information processing device as claimed in claim 1,
wherein the first resource object has a height corresponding to the potentials of all the renewable energy resources of the region, and
the second resource object has a height corresponding to the potential of the renewable energy resource of the type corresponding to the second resource object.

3. The information processing device as claimed in claim 2,
wherein the flow output from the first resource object has a width corresponding to the potentials of all the renewable energy resources of the region, and
the flow input to the second resource object has a width corresponding to the potential of the renewable energy resource of the type corresponding to the second resource object.

4. The information processing device as claimed in claim 2,
wherein the flow output from the second resource object has a width corresponding to an energy amount supplied based on the renewable energy resource of the type corresponding to the second resource object.

5. The information processing device as claimed in claim 4,
wherein the control unit, based on an operation of the user of the terminal, changes an apparent ratio of the energy amount supplied based on the renewable energy resource of the type corresponding to the second resource object with respect to the potential of the renewable energy resource of the type corresponding to such second resource object, and changes a width of the flow output from the second resource object, and
the communication unit provides the energy flow diagram after change to the terminal.

6. The information processing device as claimed in claim 5,
wherein the control unit generates the energy flow diagram based on the data of the region and calculates an energy self-sufficiency rate related to the region,
the communication unit provides the energy flow diagram and the energy self-sufficiency rate to the terminal,
the control unit, based on the operation, changes the apparent ratio, changes the width of the flow output from the second resource object, and re-calculates the energy self-sufficiency rate, and
the communication unit provides the energy flow diagram after change and the recalculated energy self-sufficiency rate to the terminal.

7. The information processing device as claimed in claim 1,
wherein the energy flow diagram comprises, in the energy conversion domain, an electric power object to which a flow corresponding to electric power converted from a non-renewable energy resource and a flow corresponding to electric power converted from a renewable energy resource are input, and a hydrogen object corresponding to energy converted into hydrogen among energy corresponding to the electric power object, and
the flow output from the electric power object is input to the hydrogen object, and the flow output from the hydrogen object is input to a demand object of the energy demand domain.

8. The information processing device as claimed in claim 7,
wherein the control unit calculates an energy-derived CO₂ emission amount of the region based on a hydrogen substitution rate, electric power converted from the non-renewable energy resource and electric power converted from the renewable energy resource, and
the communication unit provides the energy flow diagram and the energy-derived CO₂ emission amount.

9. The information processing device as claimed in claim 1,
wherein the energy flow diagram comprises, in the energy conversion domain, an electric power object to which a flow output from the energy resource domain is input, and a thermal object to which a flow output from the energy resource domain without passing through the electric power object or a flow output from the energy resource domain via the electric power object is input, and
the thermal object is arranged on a demand side with respect to the electric power object.

10. A non-transitory computer readable medium, storing a program, the program being executed by an information processing device that communicates with a terminal and comprising:
generating, through control of the information processing device, an energy flow diagram indicating a relationship between energy supply and energy demand related to a region specified by a user of the terminal based on data of the region; and
providing the energy flow diagram to the terminal by using a communication unit of the information processing device,
wherein the energy flow diagram comprises: an object arranged in each of an energy resource domain, an energy conversion domain, and an energy demand domain; and a flow from the energy resource domain toward the energy demand domain via the energy conversion domain,
the object arranged in the energy resource domain comprises: a first resource object corresponding to potentials of all renewable energy resources in the region; and one or more second resource objects, respectively corresponding to one or more types of renewable energy resources having potentials in the region, and
the flow output from the first resource object is input to the second resource object.

11. An information processing method of an information processing device that communicates with a terminal, the information processing method comprising:
generating, through control of the information processing device, an energy flow diagram indicating a relationship between energy supply and energy demand related to a region specified by a user of the terminal based on data of the region; and
providing the energy flow diagram to the terminal by using a communication unit of the information processing device,
wherein the energy flow diagram comprises: an object arranged in each of an energy resource domain, an energy conversion domain, and an energy demand domain; and a flow from the energy resource domain toward the energy demand domain via the energy conversion domain,
the object arranged in the energy resource domain comprises: a first resource object corresponding to potentials of all renewable energy resources in the region; and one or more second resource objects, respectively corresponding to one or more types of renewable energy resources having potentials in the region, and
the flow output from the first resource object is input to the second resource object.
